(19) United States
(12) Patent Application Publication
(10) Pub. No.: US 2012/0105623 A1
(43) Pub. Date: May 3, 2012

(54) System for Detecting Surface Variations on Engine Cylinder Head Valve Seats

(75) Inventors: John Christopher Pauli, Trenton, MI (US); Nicholas Amaral, Dearborn, MI (US); Francis J. Maslar, Grosse Ile, MI (US); Gregory Link, Canton, MI (US)

(73) Assignee: FORD MOTOR COMPANY, Dearborn, MI (US)

(21) Appl. No.: 12/916,715

(22) Filed: Nov. 1, 2010

(51) Int. Cl. H04N 7/18

(52) U.S. Cl. 348/92; 348/E07.085

(57) ABSTRACT

A machine vision inspection system that detects defects on machined valve seats that may be caused by a broken cutting tool insert. The system also measures the valve seat width to detect a missing cutting tool insert and monitor reactions to cutting tool forces and tool wear. The system uses high resolution cameras and stable LED light sources. A method is disclosed for manufacturing cylinder heads that are 100% inspected inline for valve seat surface defects.

### BACKGROUND

1. Technical Field

This application relates to a system for inspecting intake and exhaust valve seats after being machined in an engine cylinder head.

2. Background Art

Intake and exhaust valves are provided in engine cylinder heads. Each valve is received by a valve seat formed in a cylinder head to seal the valve. Valve seats are machined with machine tools that generally include cutting inserts. If an insert is chipped or broken, a raised ring may be left on the valve seat that creates a quality problem due to improper sealing or inadequate seat width.

Inspection of valve seats in cylinder heads is normally performed by leak testing after the valve is inserted in the cylinder head during engine assembly. Leak testing may also be referred to as “blow-by” testing. If the cylinder head is manufactured then stored or shipped to a different manufacturing facility a large number of defective heads may be manufactured before the problem is detected, which can lead to high rework or scrap costs.

Testing on a cylinder head machining line may be performed with an air leak test plug gauge but these tests are not able to detect raised ring defects reliably. Small defects caused by a broken cutting insert are not normally visible and can be missed by an air leak test plug gauge because of their size and location.

Another method of detecting valve seat defects is to inspect the valve seats with a Coordinate Measuring Machine (CMM). Inspection with a CMM is not always a reliable method to detect small surface defects such as raised ring defects that may be on the order of 10 microns wide. The use of a CMM requires substantial time and is normally performed on an audit basis pursuant to statistical process control procedures. It is not feasible to perform a CMM test on an inline basis due to the time required to conduct the test.

The above problems and shortcomings are addressed by the system described in this application.

### SUMMARY

The system disclosed in this application is a machine vision inspection system that detects raised ring defects that may be caused by a broken cutting tool insert. The system may also be adapted to measure the valve seat width and thereby reactions to cutting tool forces and tool wear. The system uses high resolution cameras and stable LED light sources to optically detect surface defects such as raised ring defects and measure the width of valve seats.

According to one aspect of the system for detecting surface defects on a valve seat, the valve seat is machined as a frustum of a cone that is oriented at a predetermined angle on a cylinder head. The system includes a camera and a light source that is aligned with the camera. A fixture holds the camera and the light source at an angle that is offset relative to an angle normal to the valve seat sealing surface. The angle of the camera and light source relative to the sealing surface creates contrast between the defect and the remainder of the machined surface. An optical output from the camera may be evaluated to determine whether a raised ring defect is present on the valve seat.

Other aspects of the disclosure include operating on a cylinder head that has a plurality of machined intake valve seats and a plurality of machined exhaust valve seats. A camera and light source is focused on an intake valve seat. A separate camera and light source is focused on an exhaust valve seat.

According to another aspect of the disclosure, a method of manufacturing a cylinder head includes the steps of machining the cylinder head to form a plurality of intake valve seats and a plurality of exhaust valve seats. The method further includes lighting the valve seat with a light source that is angularly offset from a normal direction relative to the valve seat to create an area of reduced light reflection due to a surface defect. An image is acquired of the valve seat with a camera that is focused on the valve seat and is evaluated to determine if there is a defect on the valve seat.

According to a further aspect of the disclosure a camera may be focused on a valve seat at a first radial location and a second camera may be focused on the valve seat at a second radial location. The optical output of the first camera and a second optical output of the second camera are both evaluated and compared to determine whether a raised ring defect is present on the valve seat.

Another aspect of the disclosure relates to providing a camera that is focused on a valve seat at an angle that is normal to the valve seat to measure the width of the valve seat.

Other aspects of the disclosure will be apparent to one of ordinary skill in the art to which the disclosure relates in view of the attached drawings and the following detailed description of the disclosed embodiments.

### BRIEF DESCRIPTION OF THE DRAWINGS

FIG. 1 is a fragmentary perspective view of a cylinder head;

FIG. 2 is a diagrammatic view of a machined valve seat and two machine vision inspection cameras;

FIG. 3 is a photomicrograph of a valve seat sealing surface that has a raised ring defect; and

FIG. 4 is a flowchart of the valve seat defect detection system.

### DETAILED DESCRIPTION

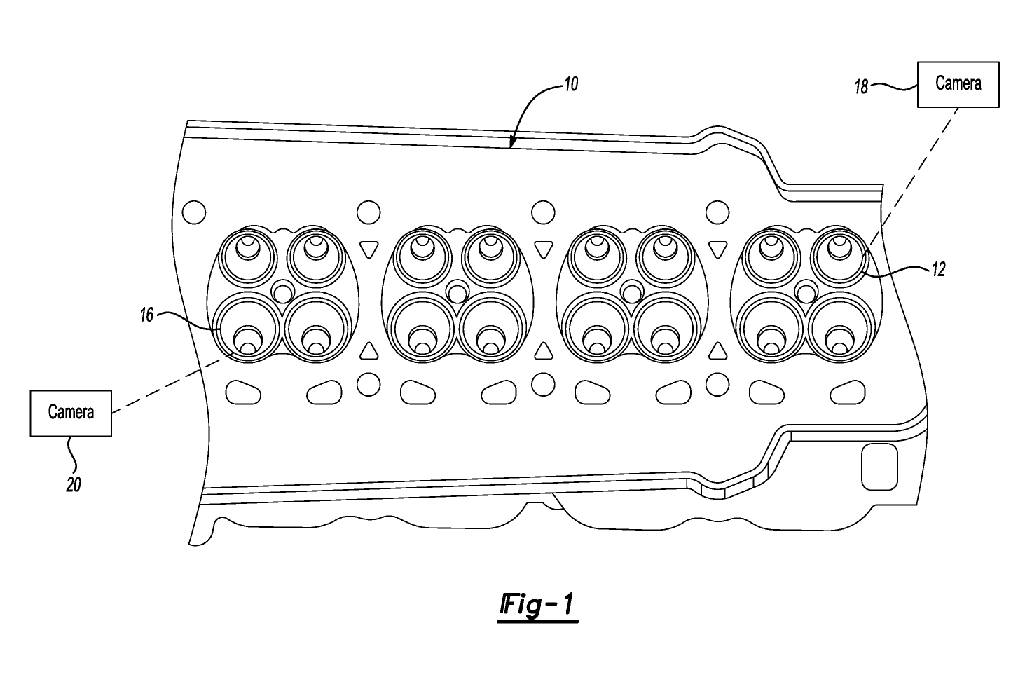

Referring to FIG. 1, a cylinder head 10 is illustrated that includes eight exhaust valve seats 12 and eight intake valve seats 16. A first defect detection camera 18 is shown with a dashed line indicating the location on the exhaust valve seat 12 that is inspected by the first defect detection camera 18. The second defect detection camera 20 is shown with a dashed line indicating the area on the intake valve seat 16 that is inspected by the second camera 20.

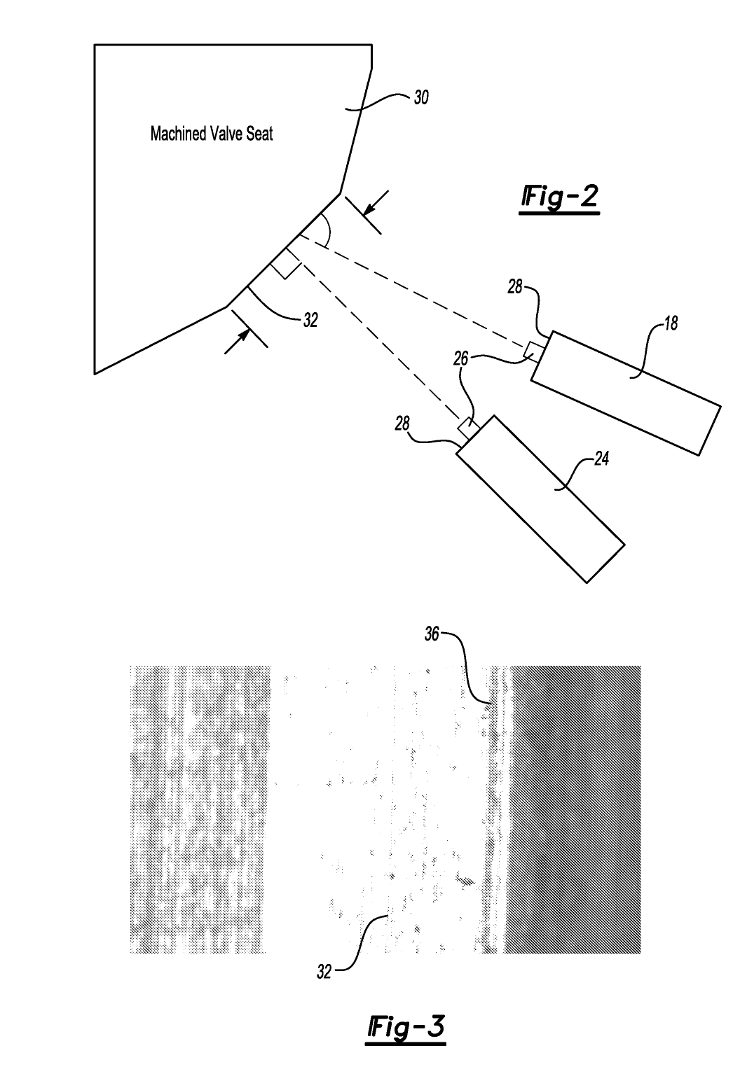

Referring to FIG. 2, a machined valve seat 30 is shown with the first defect detection camera 18 that is directed toward the valve seat sealing surface at an angle between 50° and 70° relative to the angle of the valve seat. A seat width camera 24 is also shown in FIG. 2. The seat width camera 24 may be of the same type as the defect detection cameras 18 and 20. The cameras 18, 20 and 24 may be identical and include a camera lens 26 and a stable LED light source 28. The light source 28 preferably encircles the camera lens 26. The seat width camera 24 is oriented normal to the surface of the valve seat sealing surface 32 that is formed on the machined valve seat 30.

Referring to FIG. 3, a photomicrograph of a segment of a valve seat sealing surface 32 is shown to include a raised ring defect 36. The raised ring defect 36 appears as a darkened area on the surface that is created by the light from the LED light source 28 shown in FIG. 2 reflecting off of the valve seat sealing surface 32.

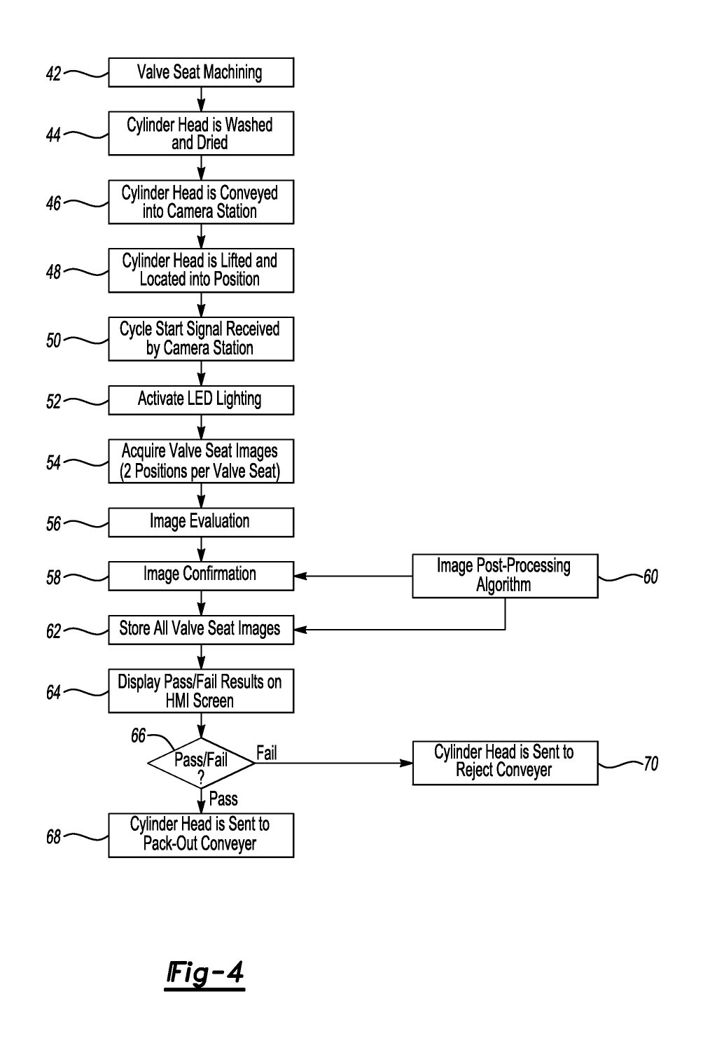

Referring to FIG. 4, a valve seat defect detection system is shown in a process flowchart. The system begins with the valve seat machining operation 42. After the valve seats 30 are machined, the cylinder head 10 is washed and dried at 44 to remove oil, coolant fluid and chips from the cylinder head 10. The cylinder head 10 is then conveyed to a camera station at 46. The cylinder head 10 is lifted and positioned at 48 in the camera station. When the cylinder head 10 is properly located at 48, a cycle start signal is received by the camera station at 50 to begin the inspection cycle.

LED lighting is activated at 52 which illuminates the valve seat sealing surface. Valve seat images are acquired at 54. Two positions may be acquired per valve seat by using two cameras that are both directed toward the same valve seat. The two cameras may provide a valve width measurement and a defect detection image or two defect detection images may be acquired to provide redundant data.

Each image is evaluated at 56. Redundant defect detection images may be compared at 58 to confirm that the valve seat sealing surface is either acceptable or that it includes a raised ring defect or other defect. The image evaluation and confirmation may be performed by an image post-processing algorithm at 60 if a computer is used to detect defects.

All of the valve seat images are stored at 62 for future reference and documentation of the test results. The results of the pass/fail inspection may be displayed at 64 on a human machine interface screen. At 66, a decision is made as to whether the cylinder head is acceptable. If so, the cylinder head is passed and the cylinder head is sent to a pack-out conveyor at 68. If the test is failed, the cylinder head is sent to a reject conveyor at 70 for further evaluation and disposition.

If a cylinder head 10 fails the test, the valve seat machining operation cutting tool inserts are inspected. If an insert is damaged or broken, the cutting tool is immediately replaced.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. A system for detecting surface defects on a valve seat that is machined as a frustum of a cone that is oriented at a predetermined angle on a cylinder head, the system comprising:
a camera;
a light source that is aligned with the camera;
a fixture that holds the camera and the light source at an angle that is offset relative to an angle normal to the valve seat sealing surface of the valve seat to contrast the surface defect with the valve seat sealing surface; and
an optical output from the camera is evaluated to determine whether a raised ring defect is present on the valve seat.

2. The system of claim 1 wherein the cylinder head has a plurality of intake valve seats and a plurality of exhaust valve seats that are machined and wherein the camera and the light source further comprise a first camera and a first light source that are focused on one of the intake valve seats and a second camera and a second light source are focused on one of the exhaust valve seats.

3. The system of claim 1 wherein the camera is a first camera that is focused on a valve seat at a first radial location and further comprising a second camera that is focused on the valve seat at a second radial location, wherein the optical output is a first optical output of the first camera and a second optical output is provided by the second camera, and wherein the first and second optical outputs are both evaluated to determine whether a raised ring defect is present on the valve seat.

4. The system of claim 3 further comprising a third camera and a third light source that is oriented at an angle that is normal to the valve seat to measure the width of the valve seat.

5. The system of claim 1 wherein the camera is a first camera that is focused on a valve seat at a first radial location for defect detection and further comprising a second camera and a second light source that are oriented at an angle that is normal to the valve seat to measure the width of the valve seat.

6. The system of claim 1 wherein the light source is an LED light source that is attached to the camera and is concentric with a lens of the camera.

7. The system of claim 1 wherein the system is utilized to inspect cylinder heads that are machined in a machining operation.

8. The system of claim 1 wherein the camera is held by the fixture at an angle of between 50° and 70° relative to the sealing surface.

9. A method of manufacturing a cylinder head comprising:
machining the cylinder head to form a plurality of intake valve seats and a plurality of exhaust valve seats;
illuminating the valve seat with a light source that is offset relative to an angle normal to the valve seat sealing surface to contrast the surface defect with the valve seat sealing surface; and
acquiring an image of the valve seat with a camera that is focused on the valve seat; and
evaluating the image to determine if there is a defect on the valve seat.

10. The method of manufacturing a cylinder head of claim 9, wherein the cylinder head has a plurality of intake valve seats and a plurality of exhaust valve seats that are machined and wherein the step of acquiring the image is performed with a first camera that is focused on one of the intake valve seats that is machined and a second step of acquiring an image is performed with a second camera and that is focused on one of the exhaust valve seats.

11. The method of manufacturing a cylinder head of claim 9 wherein the step of acquiring the image with a camera is performed, in part, using a first camera that is focused on a valve seat at a first radial location and further comprising using a second camera that is focused on the valve seat at a second radial location, wherein the step of acquiring an image is performed by obtaining a first image from the first camera and by acquiring a second image from the second camera, and wherein the step of evaluating the image includes comparing the first and second images to determine whether a raised ring defect is present on the valve seat.

12. The method of manufacturing a cylinder head of claim 11 further comprising measuring the width of the valve seat utilizing a third camera and a third light source that is oriented at an angle that is normal to the valve and acquiring a third image and measuring the third image to determine the width of the valve seat.

13. The method of manufacturing a cylinder head of claim 9 further comprising measuring the width of the valve seat utilizing a second camera and a second light source that are oriented at an angle that is normal to the valve seat to measure the width of the valve seat.

14. The method of manufacturing a cylinder head of claim 9 wherein the system is utilized to inspect every cylinder head that is machined in a machining step.
